(19) United States
(12) Patent Application Publication
(10) Pub. No.: US 2008/0054509 A1
(43) Pub. Date: Mar. 6, 2008

(54) Visually inspectable mold release agent

(75) Inventors: Ronald M. Berman, Port Orange, FL (US); Miles F. Gathright, New Smyrna Beach, FL (US)

Correspondence Address: BRINKS HOFER GILSON & LIONE, P.O. BOX 10395, CHICAGO, IL, 60610, US

(73) Assignee: Brunswick Corporation

(21) Appl. No.: 11/513,536

(22) Filed: Aug. 31, 2006

(51) Int. Cl. C04B 35/66; B29C 33/40; B29C 33/58

(52) U.S. Cl. 264/39; 106/38.22; 106/38.25; 264/338

(57) ABSTRACT

A composition that includes a mold release agent selected from one of a wax, a water-based agent, a solvent-based agent, and a semi-permanent agent and a marker material selected from one of a luminescent material, UV material, fluorescent material or dye. The composition is useful in mold preparation and maintenance activities to show the user those areas, if any, where the release agent has not been applied to the mold surface or has been inadequately applied.

### BACKGROUND OF THE INVENTION

One aspect of the present invention is to provide a visually inspectable mold release agent. Another aspect is to provid a method for visually inspecting a mold for coverage of mold release agent on the mold surface.

In preparing molded structures or parts, it is known to apply a mold release agent to the structure or part mold to allow the parts to be removed from the mold without damage to the mold or the gel coat finish of the part. For example, it is known to apply multiple coats of the mold release agent to ensure that the entire mold is covered with the mold release agent. Unfortunately, applying multiple coats of the release agent takes valuable time that could otherwise be used for production. In addition, even if multiple coats are applied, it is difficult to determine whether all the surfaces of the mold have been adequately covered until after the mold has been used, at which time of course, it is too late and the part is difficult to remove or it sticks to the mold. Moreover, the mold release agent needs to be periodically reapplied during the use of the mold. If, however, the mold release agent is not properly reapplied, the mold may degrade causing further problems.

### SUMMARY

The present invention relates to a composition containing a mold release agent and a marker material so that upon application of the composition, it can be visually determined whether the mold has been covered with the mold release agent. The present invention also includes a method to visually determine if the mold release agent layer is adequate or if reapplication of the mold release agent is desired. As a result, the time spent on the maintenance of the mold can be decreased. The present invention is defined by the following claims, and nothing in this section should be taken as a limitation on those claims.

One aspect of the present invention therefore provides a composition containing a mold release agent and a marker material. The mold release agent can be a wax, a water-based agent, a solvent-based agent, or a semi-permanent agent. The marker material may be a dye, a luminous material, such as a fluorescent material or the like, a UV visible material, or other material to cause the composition to be visibly perceptible to the human eye under one or more conditions. The one or more conditions, may be natural light, fluorescent or incandescent light, UV light, blacklight or similar light conditions.

Another aspect of the present invention is a method for preparing a mold for use. The method includes providing a film of a composition that includes a release agent and a marker material on a surface of a mold and thereafter visually inspecting the mold under conditions such that the marker material will be visually perceptible.

Another aspect of the present invention relates to a method for visually inspecting a mold for coverage of mold release agent on the surface of the mold. The method includes providing a film of a composition that includes a release agent and a marker material on a surface of a mold and thereafter visually inspecting the mold under conditions such that the marker material will be visually perceptible.

Another aspect of the present invention relates to a method for preparing a mold that includes providing a film of a composition that includes a release agent and a marker material on a surface of a mold, thereafter visually inspecting the mold under conditions such that the marker material will be visually perceptible, and subsequently providing a film of a composition that includes a release agent and a marker material on those surfaces of the mold, if any, that the visual inspection reveals have not been covered by the initial film of the composition.

### DESCRIPTION

The present invention provides a composition that includes a mold release agent and a marker material. The composition is used to provide a visual indication of the coverage of the composition on a mold surface.

A release agent is a material that forms a chemically inert, i.e., nonreactive film with sufficient heat resistance for its intended process. The release agent also has a surface energy or slip to allow the agent to thoroughly wet the mold surface when applied, permit the part resin or gel coat to flow and form a consistent film on its dried or cured surface, and enable separation of the cured part.

There are generally four types of release agents; a wax, a water-based agent, a solvent-based agent, and a semi-permanent agent. Any of the known types of release agents are suitable for use in the present invention.

Waxes are generally in the form of a paste such as carnuba wax or in the form of a liquid such as synthetic wax polymers or a combination of natural and synthetic materials such as aqueous carnuba wax and a silicone-based material. Waxes generally need to be buffed after application to provide a smooth, high-gloss barrier.

Water-based release agents can include water soluble polymers such as polyvinyl alcohol or can be formulated as a dispersion containing polymers or materials such as polytetrafluoroethylene (PTFE), fluorochemical or resin-based formulations that contain silicone or not.

Solvent-based release agents include resins or other materials that are soluble in the solvent. Such other materials can include polymers and silicones. Typically, the solvent is non-aqueous and generally, hydrocarbon based such as such as petroleum hydrocarbons, aliphatic hydrocarbons, naphtha and naphtha containing material, blends of aliphatic hydrocarbons and naphtha or naphtha blends or petroleum hydrocarbons.

Semi-permanent release agents are those that bond to the mold surface rather than to the part being manufactured. Generally, semi-permanent release agents are polymers or resins that cross-link and cure on the mold surface to form a film that, when cured, is highly chemical resistant. The semi-permanent release agents can be supplied as water-based or solvent-based products.

Exemplary suppliers of suitable release agents include but are not limited to Henkel (Loctite® Frekote® WOLO™ and SOLO™ products), Axel Plastics (XTEND®, MoldWiz®), PasteWiz® products), Zyvax Inc. (Flex-Z® and Composite Shield™ products), and Chem-Trend (Chemlease® products).

The marker material is selected from one of a dye, a luminous material, such as a fluorescent material or the like, a UV visible material, or other material to cause the composition to be visible to the human eye under one or more conditions. The one or more conditions, may be natural light, fluorescent or incandescent light, UV light, blacklight or similar light conditions. In one aspect, the marker material, when combined with the release agent is not visibly perceptible unless subjected to a light condition different than natural light, incandescent light, or fluorescent light. For example, the marker material may be a luminous material that is visible only under black light conditions. Consequently, when the composition is applied under natural, incandescent, or fluorescent light, and left to dry, the areas of the mold that do not contain the composition cannot be seen, unless the mold is viewed under black light conditions.

Where the marker material is not soluble in the solvent for the release agent, it is desirable that the marker material have a particle size that is less than the desired thickness of each layer of the composition to be applied to the surface of the mold, if the marker material is supplied as a solid, and yet still provide the desired visual effect. Accordingly, it is desired that if the marker material is supplied as a solid, the marker material will have a particle size less than about 100 microns, or less than about 50 microns, or less than about 20 microns, or less than about 15 microns, or less than about 10 microns, or less than about 5 microns, or less than about 1 micron. In one aspect, the marker material may have a particle size from about 1 nm to about 100 microns. In this regard, the marker material may have a particle size from about 10 nm to about 50 microns or from about 100 nm to about 20 microns.

The amount of marker material to be included in the composition will be that amount necessary to be visually perceptible under suitable conditions when the composition is applied to the mold. Generally, the amount of release agent in the composition will be greater than the amount of marker material. For example, the ratio of the release agent to the marker material is from about 1:1 to about 1000:1 (by weight). In one aspect, the ratio of the amount of release agent material to the amount of marker material is from about 5:1 to about 100:1, alternatively from about 10:1 to about 50:1, alternatively from about 20:1 to about 40:1, alternatively about 25:1.

Another aspect of the present invention is directed to a method of preparing a mold for use or for visually inspecting a mold. Each method includes providing a composition containing a mold release agent and a marker material on a surface of a mold and thereafter visually inspecting the mold under conditions such that the marker material will be visually perceptible, and subsequently providing a film of a composition that includes a release agent and a marker material on those surfaces of the mold, if any, that the visual inspection reveals have not been covered by the initial film of the composition.

The composition can be provided to the mold surface by hand wiping or spraying. For hand wiping, the composition may be applied by applying the composition to a cloth or paper towel. Suitable cloths as Scott Shop Towels On A Roll®, Kimberly-Clark WorkHorse® rags or WypAll® wipes. Any excess composition on the towel should be squeezed out so that the towel is uniformly saturated but is not dripping. The composition is then applied to the mold surface using smooth even strokes. It is desired to wipe the composition on the mold surface and allow it to dry and/or cure.

For spraying, it is desired to provide the composition in a hand pump spray botttle that can provide a mist to the surface of the mold. The composition on the mold can then be smoothed out or worked into difficult surface areas using a natural bristle brush, a foam paint applicator, or a towel. Alternatively, the composition may be provided with a high volume low pressure spray gun or or other application apparatus.

The composition is desirably provided on the surface of the mold in one or more layers with each layer having a thickness of from about 1 to about 100 microns, or from about 5 to about 50 microns or from about 10 to about 20 microns, or from about 15 microns. Thereafter, the mold surface is visually inspected to determine if any surface of the mold does not contain the composition. The visual inspection is conducted under the conditions appropriate for the marker material to be visually perceptible. For example, where the marker material is a luminous material that is visible under black light conditions, the visual inspection is conducted under black light conditions.

Another aspect of the present invention includes subsequently providing a film of a composition that includes a release agent and a marker material on those surfaces of the mold, if any, that the visual inspection reveals have not been covered by the initial film of the composition.

The foregoing detailed description has described only a few of the many forms that this invention can take. For this reason, this detailed description is intended by way of illustration, and not by way of limitation. It is only the following claims, including all equivalents that which are intended to define the scope of this invention.

What is claimed:

1. A composition comprising a mold release agent and a marker material.

2. The composition of claim 1 wherein the mold release agent is selected from one of a wax, a water-based agent, a solvent-based agent, and a semi-permanent agent.

3. The composition of claim 1 wherein the marker material causes the composition to be visible to the human eye under one or more conditions.

4. The composition of claim 3 wherein the marker material is one of a luminescent material, UV material, fluorescent material, or dye.

5. The composition of claim 1 wherein the ratio of the amount of release agent to the amount of the marker material is from about 1:1 to about 1000:1

6. The composition of claim 1 wherein the ratio of the amount of release agent to the amount of the marker material is from about 5:1 to about 100:1

7. The composition of claim 1 wherein the ratio of the amount of release agent to the amount of the marker material is from about 10:1 to about 50:1

8. The composition of claim 1 wherein the ratio of the amount of release agent to the amount of the marker material is from about 20:1 to about 40:1

9. The composition of claim 4 wherein the marker material is a solid having a particle size less than about 100 microns.

10. The composition of claim 4 wherein the marker material is a solid having a particle size less than about 50 microns.

11. The composition of claim 4 wherein the marker material is a solid having a particle size less than about 15 microns.

12. The composition of claim 4 wherein the marker material has a particle size from about 1 nm to about 100 microns.

13. A method for preparing a mold for use comprising; providing a film of a composition that includes a release agent and a marker material on a surface of a mold; and subsequently visually inspecting the mold under conditions such that the marker material will be visually perceptible to determine an area of the mold where the composition has not been provided.

14. The method of claim 12 further comprising providing a film of the composition to the area of the mold where the composition has not been provided.

15. The method of claim 13 further comprising visually inspecting the mold under conditions such that the marker material will be visually perceptible.

16. The method of claim 12 wherein the mold release agent is selected from one of a wax, a water-based agent, a solvent-based agent, and a semi-permanent agent.

17. The method of claim 12 wherein the marker material causes the composition to be visible to the human eye under one or more conditions.

18. The method of claim 14 wherein the marker material is one of a luminescent material, UV material, fluorescent material, or dye.

19. The method of claim 12 wherein the ratio of the amount of release agent to the amount of the marker material is from about 1:1 to about 1000:1

20. The method of claim 12 wherein the marker material is a solid having a particle size less than about 100 microns.
